(19) United States
(12) Patent Application Publication
(10) Pub. No.: US 2020/0164558 A1
(43) Pub. Date: May 28, 2020

(54) INJECTION-MOULDING METHOD FOR CREATING VIRTUAL THREE-DIMENSIONAL PATTERNS IN MOULDED BODIES

(71) Applicant: MERCK PATENT GMBH, DARMSTADT (DE)

(72) Inventors: Michael KAEMMERER, Aschaffenburg (DE); Markus SCHUM, Reichelsheim (DE); Marc HUNGER, Viernheim (DE); Laurent DELOUX, Heidelberg (DE)

(73) Assignee: MERCK PATENT GMBH, DARMSTADT (DE)

(21) Appl. No.: 16/619,834

(22) PCT Filed: May 23, 2018
(86) PCT No.: PCT/EP2018/063469

§ 371 Date: Dec. 5, 2019

(30) Foreign Application Priority Data
Jun. 7, 2017 (EP) 17174803.1

(51) Int. Cl. B29C 45/14; B29L 31/00; B32B 27/08

(52) U.S. Cl. CPC B29C 45/14688; B29C 45/14811; B29C 45/14827; B32B 27/08; B29L 2031/722; B29C 2045/14713; B29K 2995/0026; B29K 2995/002

(57) ABSTRACT

The present invention relates to a process for the generation of virtual three-dimensional patterns in mouldings, in particular to a reactive injection-moulding process for the production of mouldings having a virtual three-dimensional pattern which is formed by flake-form effect pigments, to the mouldings produced by means of this process, and to the use thereof, in particular for decorative purposes.

The present invention relates to a process for the generation of virtual three-dimensional patterns in mouldings, preferably of plastic mouldings, and in particular to a reactive injection-moulding process for the production of mouldings which have on at least one of their surfaces a virtual three-dimensional pattern which is formed by flake-form effect pigments, to a moulding which has a virtual three-dimensional pattern of this type, and to the use thereof.

Decorative three-dimensional patterns on plastic articles are known and have already been in use for some time. They provide the said goods with an exclusive appearance which suggests depth and differs from conventional patternings in an advantageous manner. The mouldings or films are frequently embossed or otherwise structured on at least one of their surfaces in order ultimately to have a three-dimensional pattern. In order to achieve particular optical effects, both mouldings and also films are often assembled in multiple layers and embossed in the layer composite. In addition, they may also be provided with functional and/or decorative coatings, usually in the form of paints, which may optionally also comprise metal-effect pigments and the like in order, for example, to increase the gloss of the three-dimensional structures.

Structuring processes of this type are often associated with high equipment complexity. Three-dimensionally embossed surfaces of polymeric mouldings additionally have the disadvantage that they are susceptible to dirt and can only be protected inadequately against mechanical deformations.

Various processes have therefore already been developed with the aid of which polymeric mouldings, which are generally films, can be provided with three-dimensional patterns in such a way that although these patterns are visually perceptible, they are not haptically perceptible to the observer.

Thus, for example, JP-A-07-137221 and JP-A-05-092538 disclose decorative layer systems which in each case contain embossed or otherwise structured layers, which may also comprise lustre pigments, usually applied via printing inks, between a polymeric substrate and a polymeric top layer. The production of composite materials of this type requires a multiplicity of different working steps and complex lamination or other bonding of different material layers to one another. In addition, only flat, i.e. substantially two-dimensional mouldings, such as, for example, decorative films, can be produced in this way, while mouldings having a pronounced three-dimensional shape cannot be produced.

DE 10 2004 041 833 A1 discloses a process for the production of a decorated injection-moulded article, in which a transfer film which contains a decorative element which is located on a support film provided with a release layer is coated with a plastic injection-moulding composition on the side facing away from the support film in an injection mould, the support film is subsequently detached, and the moulding prefabricated in this way is likewise coated with an injection-moulding composition on the transfer film side in a second injection mould. The resultant polymeric moulding contains in the interior the transfer film's transfer layer containing the decoration. The decoration can be a hologram or diffractive structures, which remain unchanged during the two injection-moulding steps and are visible on both sides in the resultant polymeric moulding.

Although optically attractive polymeric mouldings having patterns which cannot be felt haptically and in which the patterns may have three-dimensional shapes are formed in this process, a process of this type can only be implemented with high equipment complexity and material costs. Thus, multilayered transfer films with pattern interlayers produced in a complex manner firstly have to be prefabricated and subsequently have to be coated successively on both sides by means of two different injection moulds. A process of this type is much too complex for the production of mass-produced articles and therefore cannot be employed economically.

In addition, using the process mentioned above, it is only possible to produce mouldings which consist predominantly of polymeric plastics. The process is not suitable for the production of composite mouldings which, besides the plastic component, also consist of not inconsiderable proportions by weight of other materials, for example of metals.

EP 2960039 A1 discloses an injection-moulding process for the generation of three-dimensional patterns in plastic mouldings in which a thermoplastic film which has been pigmented with effect pigments is provided in an injection mould with a three-dimensional pattern on its reverse and at the same time is coated with a thermoplastic composition on its front. Plastic mouldings which have a readily visible three-dimensional pattern are produced. However, this process is also unsuitable for the production of composite mouldings which also contain significant amounts of other materials apart from plastics. In addition, surfaces comprising thermoplastics are of only limited suitability for applications which require high impact strength and/or scratch resistance.

It would therefore be desirable to have available a simple, fast and comparatively inexpensive process for the production of mouldings which is equally suitable for the production of polymeric mouldings and of composite mouldings which in each case have a two- or three-dimensional outer shape, where the mouldings exhibit, on viewing of their surface, an optically, but not haptically, perceptible pattern with a three-dimensional appearance, and the surface is distinguished by high scratch resistance and/or impact strength, where the process can be carried out with few process steps and with conventional moulds, and where the pattern is an attractive, glossy pattern with a three-dimensional appearance in the interior of the moulding, and to mouldings produced in this way.

The object of the present invention therefore consists in providing a process which allows the production of glossy patterns having a three-dimensional appearance with fine line structures inside two- or three-dimensionally shaped mouldings of a very wide variety of compositions which have a mechanically stable, visually attractive surface, in few working steps by means of moulding processes and apparatuses known per se and facilitates a great variation latitude in shape and material composition of the resultant mouldings.

A further object of the present invention consists in providing two- or three-dimensional mouldings which, on viewing of at least one of their surfaces, exhibit a glossy pattern having a three-dimensional appearance with fine line structures which is located in the interior of the moulding, without having on their mechanically stable surface an equally three-dimensional pattern, where the mouldings may optionally consist to a considerable proportion of material other than plastics.

An additional object of the present invention consists in indicating the use of the mouldings produced in this way.

The object of the present invention is achieved by a reactive injection-moulding process for the generation of virtual three-dimensional patterns in mouldings, where
an injection mould is provided which has injection mould parts A and B which can be separated from one another and which in each case have an inside surface A′ and B′ and together form an interior cavity, and where, with the injection mould opened,
a preform which has a two- or three-dimensional shape and an outside surface is fixed to the inside surface A′ of injection mould part A in such a way that the outside surface of the preform faces the cavity, where this outside surface has, at least on a part-area thereof, bumps and/or pits which together form a three-dimensional pattern,
a thermoplastic film which has been pigmented with flake-form effect pigments is introduced into the interior cavity,
the injection mould is closed,
a mixture of at least two flowable components which react with one another with polymerisation is introduced into the interior cavity between the thermoplastic film and the surface a of injection mould part B, so that the thermoplastic film is at least partly flooded, where the flowable components solidify with one another by polymerisation to give a transparent plastic and the thermoplastic film forms a strongly adherent and positive bond to at least that part of the outside surface of the preform that contains the three-dimensional pattern and at the same time to the transparent plastic formed during the polymerisation, and
where the flake-form effect pigments replicate and optically enhance the three-dimensional pattern located on the outside surface of the preform on or in the thermoplastic film,
the injection mould is heated or cooled and subsequently
the resultant moulding, which has an outside surface comprising a transparent plastic and exhibits on at least part of this outside surface a virtual three-dimensional pattern formed by the flake-form effect pigments, is demoulded or removed.

Furthermore, the object of the invention is achieved by a moulding which consists of a preform, an interlayer of a thermoplastic which has been pigmented with flake-form effect pigments, located on the preform, and an outer surface layer comprising a transparent plastic, where the outer surface layer exhibits, on at least one part-area thereof, a visually perceptible, virtual three-dimensional pattern formed in the interior of the moulding by the flake-form effect pigments, and where the outer surface layer of the moulding itself has no corresponding spatial three-dimensional pattern, produced by the process described above.

In addition, the object of the invention is also achieved by the use of the moulding described above as decorative and/or labelling element or part of durable consumer goods.

The present invention therefore relates to a reactive injection-moulding process for the production of a two- or three-dimensionally shaped moulding in which a glossy pattern having a three-dimensional appearance is visible on at least part of its outside surface and is not present in the same way in a spatially three-dimensional manner on this part of the surface, i.e. represents a virtual three-dimensional pattern, and in which the outer surface as high impact strength and/or scratch resistance.

The injection-moulding process according to the invention corresponds in its essential working steps to a reactive injection-moulding process (RIM technology), which has been known for some time, in which a partable injection mould is employed whose interior cavity corresponds to the final shape of the plastic moulding to be produced. A prefabricated base plastic moulding, which may also have been produced beforehand directly in another cavity of the same injection mould (multistep or single-step process), is introduced into this cavity, where the base plastic moulding is subsequently covered on at least one of its outside surfaces with a mixture of reactive, flowable starting materials which are capable of polymerisation with one another, and the resultant surface coating of the base plastic moulding is allowed to solidify in the injection mould. The solid surface coating formed on the plastic moulding corresponds in principle to direct painting inside the injection mould. The plastic moulding produced is subsequently demoulded or removed from the opened injection mould.

Such processes and the special injection moulds and reactive materials developed for this purpose and are known per se and are available from various manufacturers under the names ColorForm, SkinForm, Clearmelt, etc. They represent a combination of a conventional injection-moulding process, which works with thermoplastic compositions, and PUR technology, since most of the reactive starting materials employed for the final surface coating are polyol/isocyanate mixtures.

Both an injection mould for one-step RIM technology (one-shot process) and also an injection mould for multistep RIM technology can be employed for the process according to the invention.

In the so-called one-step process, the production of the preform (corresponds to the base plastic moulding in the known reactive injection-moulding process described above) and the surface coating thereof take place within a single injection mould. Firstly, the preform is produced in a conventional injection-moulding process from thermoplastic compositions in a first cavity of the injection mould. In this upstream process step, the preform, which can in accordance with the invention have a two- or three-dimensional shape, is provided on at least part of its outside surface with bumps and/or pits, which together form a three-dimensional pattern. After curing of the preform, the injection mould is opened and the preform is transferred via a suitable turning, rotating or pushing devices into a second cavity of the injection mould, which in accordance with the invention has the inside surfaces A′ and B′, where inside surface A′ already carries the preform and was also part of the first cavity of the injection mould. The three-dimensional pattern consisting of the bumps and/or pits on the surface of the preform faces the cavity, which is located between this outside surface of the preform and the inside surface B′ of the second cavity.

In accordance with the present invention, a transparent thermoplastic film which has been pigmented with flake-form effect pigments is subsequently introduced into the second interior cavity of the injection mould and optionally fixed there. The transparent thermoplastic can be introduced either into injection mould part A or injection mould part B. Temporary fixing of the film can be carried out, for example, by application of a vacuum, electrostatically, via adhesive dots which can easily be detached on exposure to elevated temperature, or other suitable, temporary fixing measures, such as, for example, clamps or frames.

After the thermoplastic film pigmented with the flake-form effect pigments has been introduced into the second interior cavity of the injection mould, the injection mould is closed and a mixture of at least two flowable components which react with one another with polymerisation is introduced into the remainder of the cavity of the injection mould between the thermoplastic film and surface B′ of injection mould part B. Injection mould part A with inside surface A′ represents the ejector half and injection mould part B with inside surface B′ represents the fixed half of the injection mould. It goes without saying that the nozzles must have a corresponding technical design which ensures rapid introduction of the reactive starting components into the second cavity and prevents premature polymerisation of the reactive starting mixture. The temperature and pressure programme and the design of the injection mould equipment must also be matched correspondingly. However, these design prerequisites exist in the equipment present in the prior art.

Due to the generally very low viscosity of the mixture of the reactive starting components, the remainder of the cavity is completely filled very rapidly with this mixture. The introduction of the mixture of the reactive starting components into the second interior cavity of the injection mould is preferably carried out at only moderately increased pressure (0.5 to about 15 MPa) and at elevated temperature, in each case depending on the materials used. Due to the effect of the heated reactive starting compounds and the pressure and temperature that the liquid reactive starting compounds exert on the pigmented thermoplastic film during the introduction into the cavity of the injection mould and during the polymerisation reaction, the thermoplastic film reaches a temperature and elasticity which allows mechanical deformation of the film. The specific temperature of the starting components in each case depends on the type of the starting components processed and their reactivity and is usually in the range from 20° C. to 150° C., preferably from 40° C. to 70° C., with a usual mould temperature in the range from 40 to 180° C. If necessary, the reaction can also take place under inert gas, for example in a nitrogen atmosphere.

The polymerisation reaction and solidification (crosslinking) of the at least two reactive starting components with formation of a transparent plastic takes place within the injection mould within a short period (about 0.5 to 5 min).

During the introduction and solidification of the mixture of at least two flowable components which react with one another with polymerisation into the injection mould, the thermoplastic film warms and expands in a surprising manner in spite of the comparatively low working temperatures to such an extent that it becomes mechanically deformable and is able to come into close contact with the outside surface of the preform, which faces the second interior cavity of the injection mould, in a form-fitting manner. Depending on the size and shape of the thermoplastic film, the thermoplastic film fully or partly bonds to at least part of the outside surface of the preform, in particular to the part of this outside surface that has the three-dimensional pattern. At the same time, a bond is also formed to the transparent plastic formed in the polymerisation reaction of the reactive starting components introduced. Both with respect to the preform and also with respect to the transparent plastic formed by in situ polymerisation, this is a strong and positive bond to the thermoplastic film, meaning that the latter is permanently enclosed in the interior of the resultant moulding.

The three-dimensional pattern present on the outside surface of the preform is replicated as negative on the film surface facing this outside surface of the preform. Since the polymeric thermoplastic material of the film softens, the film is likewise deformed three-dimensionally, at least on its surface facing the outside surface of the preform, in the area units that are in contact with the three-dimensional pattern located there. This thermal deformation of the film can continue over the entire cross section of the thermoplastic film, but may also take place only in its area of contact with the preform, so that the film surface facing the introduced mixture of the reactive flowable components remains three-dimensionally undeformed, i.e. does not have the three-dimensional positive of the three-dimensional pattern. At the same time, the softening of the polymeric film material enables renewed mobility of the flake-form effect pigments present in or on the thermoplastic film. These are usually present in predominantly directed form in or on the thermoplastic, but as yet thermally untreated film, more precisely with their principal axis aligned substantially parallel to the film surface. This alignment can be obtained by the extrusion process preferably employed for the film production with subsequent mass colouring of the film or also by various coating processes, in which the film is coated or printed with coating compositions comprising effect pigments, since the tensile and shear forces exerted with these processes automatically lead to parallel alignment of flake-form effect pigments. The mobility of the flake-form effect pigments achieved via the thermal treatment in the injection mould leads to reorientation of the longitudinal axes of the effect pigments at the bumps and/or pits which are formed by the three-dimensional pattern in the surface of the film facing the preform that has been transferred from the surface of the preform. The flake-form effect pigments are moved out of their parallel orientation at the edges of these bumps and/or pits and remain at an acute or steep angle in the thermoplastic polymeric composition of the film in an alignment which is inclined in relation to the film surface. This changes the reflection behaviour of the flake-form effect pigments at these points of the film, which leads to generally reduced reflection compared with the flat areas at a steep viewing angle. In this way, the flake-form effect pigments in or on the thermoplastic film replicate the three-dimensional pattern on the outside surface of the preform and optically enhance it through their reflection behaviour adapted thereto.

At the same time, the heated mixture of at least two flowable components reacting with one another with polymerisation flows into the cavity between the thermoplastic film and the inside surface B′ and covers the three-dimensional pattern which is visible due to reflection of the flake-form effect pigments and which, viewed from the outside surface of the film that is not bonded to the preform, is identical in appearance to the actual three-dimensional pattern on the outside surface of the preform, but, due to the light reflections emanating from the pigments, can be perceived more clearly and optically more attractively. During subsequent solidification and curing of the moulding produced in this way, a strong, positive bond forms between the thermoplastic film pigmented with flake-form effect pigments and the preform on the one hand and the transparent plastic formed from mixture of reactive, flowable components capable of polymerisation on the other hand, which is manifested in the subsequent cooling or heating operation. The reorientation of the effect pigments is fixed during the polymerisation process of the flowable reactive starting components. A more clearly visible reorientation of the flake-form effect pigments can be achieved here with mass-coloured thermoplastic films than with printed or coated films, especially as damage to the surface during the reshaping does not have to be expected here.

The outer layer of transparent plastic which forms the outer visible surface of the resultant moulding additionally enhances the virtual three-dimensional pattern of flake-form effect pigments obtained in the interior of the moulding through an additional optical depth effect.

When the moulding has solidified sufficiently, it can be demoulded or removed from the injection mould. Subsequent curing, which is necessary in most cases, then takes place outside the injection mould.

The resultant moulding has an outer shape which is determined by the shape of the preform the one hand and by the shape of the inside surface B′ of the injection mould on the other hand. Viewed from the side of the transparent polymeric plastic (i.e. the outside surface of the moulding), which is generally the “visible side” of the moulding obtained, the moulding in accordance with the present invention exhibits in its interior a virtual, deep-lying, glossy, three-dimensional pattern which is formed from flake-form effect pigments. If the surface B′ of injection mould part B is a polished surface usually employed, the resultant polymeric moulding does not have on its outside surface (visible side) a three-dimensional shape which corresponds to the three-dimensional effect pigment pattern visible in the interior of the moulding. Nevertheless, however, the surface B′ of the injection mould may likewise have a coarse or fine texture which leads, in the resultant moulding, to a coarse or fine structure on its outside surface, which additionally three-dimensionally enhances or supplements the three-dimensional pattern visible in the interior of the moulding.

The colouring, functionality and gloss behaviour of the virtual three-dimensional pattern corresponds to the colouring, functionality and gloss behaviour of the pigmented thermoplastic film. Colouring, functionality and gloss behaviour of the thermoplastic film are crucially influenced by the flake-form effect pigments present therein, optionally supplemented by additional colourants and/or fillers which are also located in or on the thermoplastic film.

Gloss and colouring of the flake-form effect pigments lead to particularly strong perception of the virtual three-dimensional pattern on the surface of the moulding produced. The visible three-dimensional pattern here is significantly more pronounced than the actual deformation of the thermoplastic film would suggest, since movement of the flake-form effect pigments out of the parallel position, even by only a few angle degrees, results in a significant change in their reflection properties. Viewed at the respective specular angle, however, the gloss achieved by the effect pigments is retained over the entire area of the part of the moulding formed by the thermoplastic film.

This relates, in particular, to the moulding's outer surface layer which is formed from the transparent plastic produced in situ and, as described above, generally represents the “visible side” of the moulding formed. If the preform is likewise formed from a transparent plastic, the three-dimensional pattern may optionally also be visible on its inside surface. Particularly good visibility of the three-dimensional pattern on the outside surface of the resultant moulding arises if the preform is opaque and/or has preferably been coloured grey or black, in particular if the thermoplastic film has been pigmented with flake-form effect pigments which consist entirely of transparent materials and only have interference colours, but no absorption colour.

If the transparent plastic produced in situ comprises a soluble colorant or small amounts of a particulate colorant, the colouristic impression, perceptible from the side of the outside surface of the resultant moulding, of the virtual three-dimensional pattern can also be modified as desired. Although soluble colorants result in an inherent colour of the plastic produced in situ and of the moulding part produced therewith, they have, however, virtually no or absolutely no adverse effect on the transparency of this part of the moulding.

Besides the one-step RIM process, the use of a multistep RIM process is also particularly suitable for the reactive injection-moulding process according to the invention. Compared with the one-step RIM process, this process has the advantage that it is possible to employ preforms which can consist of composite material or entirely of materials other than polymeric plastics, for example ceramic, metals or carbon fibres, whereas the preform in the one-step RIM process consists of thermoplastics.

On use of a multistep RIM process, the preform is produced separately in advance. It is unimportant here whether the preform is likewise produced in an injection-moulding process or by other manufacturing processes. If a multistep RIM process of this type is used in the process according to the invention, the injection mould employed has only a single interior cavity, which is formed by the inside surfaces A′ and B′ of injection mould parts A and B.

For this purpose, an injection mould which is suitable for an RIM process, which has an insert or another device which is capable of accommodating a preform in one of the injection mould parts (injection mould part A) is provided. This preform can have a two- or three-dimensional shape, where, for the purposes of the present invention, flat structures, such as, for example, films or plates, are to be regarded as two-dimensional, whereas other spatial structures which do not have a flat shape are to be regarded as three-dimensional. Three-dimensional preforms are not restricted in shape, so long as the injection mould is able to accommodate the corresponding preforms and the latter can be fixed to, in or on the inside surface A′ of injection mould part A.

The preform here is fixed to the inside surface A′ in such a way that its outside surface faces the cavity of the injection mould (in accordance with the invention, outside surface of the preform is taken to mean: one of the two principal surfaces of a film or plate, the convex surface or part-areas thereof in the case of three-dimensional hollow bodies or at least part of the entire outside surface in the case of three-dimensionally shaped bodies having a closed surface).

The preform can be a polymeric preform which consists predominantly of plastic, but may also be a preform which consists to a predominant part of a material other than plastic, has already described above.

Preforms which essentially consist of materials other than plastic are, for example, preforms made from metals, ceramic or modified glass fibres. These may, but do not have to, have been produced by an die-casting process. Metals which come into consideration are, in particular, aluminium, steel, zinc or also copper alloys. Ceramic preforms may have been produced from sinterable ceramic materials. Carbon fibres are generally reinforced with resins and in this form are likewise suitable for the production of preforms. Of these, metal preforms are preferred.

All further process steps here correspond to the process steps described above using a one-step process, namely:

After the preform, which has a two- or three-dimensional shape and an outside surface, has been fixed to the inside surface A′ of injection mould part A in such a way that the outside surface of the preform faces the cavity, where this outside surface has, at least on a part-area thereof, bumps and/or pits which together form a three-dimensional pattern, a thermoplastic film which has been pigmented with flake-form effect pigments is introduced into the interior cavity. The injection mould is subsequently closed and a mixture of at least two flowable components which react with one another with polymerisation is subsequently introduced into the interior cavity between the thermoplastic film and surface B′ of injection mould part B, so that the thermoplastic film is at least partly covered, where the flowable components solidify with one another by polymerisation to give a transparent plastic and the thermoplastic film forms a strong and positive bond to at least that part of the outside surface of the preform that has the three-dimensional pattern, and the same time to the transparent plastic formed during the polymerisation. The flake-form effect pigments here replicate the three-dimensional pattern located on the outside surface of the preform on or in the thermoplastic film and optically enhance this pattern. The injection mould is subsequently heated or cooled, depending on the type of components employed, and the resultant moulding is subsequently demoulded or removed. The resultant moulding has an outside surface comprising a transparent plastic, where a virtual three-dimensional pattern formed by the flake-form effect pigments is visible at least on part of this outside surface, but is not present on the surface itself. The outside surface serves merely as optical enhancement medium for the three-dimensional pattern formed inside the moulding by the flake-form effect pigments and can be glossy or matt, smooth or structured, hard or with a soft-touch effect, depending on the thickness and material nature. In each case, the outside surface provides the resultant moulding with the desired impact strength and/or scratch resistance.

The following explanations apply irrespective of whether one-step or multistep RIM technology is employed for the process according to the invention.

Polymeric preforms may comprise, as polymeric component, various thermoplastics, for example polystyrene (PS), polyethylene (PE), polyamide (PA), polypropylene (PP), polycarbonate (PC), polymethyl methacrylate (PMMA), polystyrene blends, styrene-acrylonitrile (SAN), various thermoplastic elastomers (TPEs or TPOs), thermoplastic polyurethanes (TPUs), polyoxomethylene (POM), acrylate-styrene-acrylonitrile (ASA) or acrylonitrile-butadiene-styrene (ABS) or ABS/PC blends, to mention just a few. It is also possible to employ further copolymers, other than those mentioned above, which contain the above-mentioned polymers. In addition, polymeric preforms may also comprise, as polymer constituent, various thermosetting plastics, such as, for example, melamine/phenolic resins (MP/MF), melamine/polyester resins (MPV), unsaturated polyester resins (UP) of phenolic resins (PF). Various rubbers or silicones are also suitable as polymer constituent of the polymeric preforms. The polymeric preforms can be produced by injection moulding from the materials mentioned above. Alternatively, however, the preform can also be produced by compression moulding, foaming or a separate RIM process. In this case, the range of suitable polymer materials is broadened and they may additionally also contain polyethylene terephthalate (PET), polybutylene terephthalate (PBT), cyclic polyolefins (COC), polypropylene oxide (PPO), polyphenylene sulfide (PPS), polyurethane (PUR), epoxy resins (EP), polyvinyl chloride (PVC) or mixtures thereof.

Further ingredients are optionally additives and assistants which are able to influence the mechanical strength, the functional properties or the optical properties of the preforms, for example reinforcing glass or carbon fibres, carbon blacks, conductive additives, particulate fillers and/or inorganic or organic colourants, as well as further assistants and additives.

The polymeric preforms are transparent, semitransparent or opaque and can be in both colourless and coloured form, in particular also coloured grey or black.

The preform here has on at least one part-area of its outside surface, optionally also on the entire outside surface, bumps and/or pits which together form a three-dimensional pattern. This pattern is preferably macroscopically visible and is, for example, in the form of a pictorial object, an alphanumeric motif, a line and/or dot pattern, a logo, a code or an abstract pattern.

For the purposes of the present invention, it is important that the three-dimensional pattern on the outside surface of the preform does not correspond to the outer shape of the preform, i.e. the bumps and/or pits forming the pattern on the surface of the preform do not form its outer shape, but instead are present in addition to possible bumps and/or pits on the outside surface of the preform which determine the outer shape and are clearly evident as texture of the outside surface. Thus, for example, in the case of a preform which has the outer shape of a hemisphere located on a flat plate, the pattern in accordance with the present invention is not represented by the hemispherical bump on the plate body, although this is likewise a bump on the outside surface, but instead, for example, by a three-dimensionally embossed logo on the hemisphere or the plate body.

In accordance with the invention, the three-dimensional pattern on the outside surface of the preform has bumps and/or pits which can have a height/depth from about 2 μm to a few centimetres and line widths of 50 μm to 2000 μm. The height/depth of the bumps/pits is preferably 10 μm to 50 mm, in particular from 10 μm to 500 μm, and the line widths are preferably in the range from 100 μm to 1000 μm. The area extent of the three-dimensional pattern can range from a few square millimetres to a several hundred square centimetres. These dimensions essentially depend on the size and wall thickness of the preform and on the function that the virtual three-dimensional pattern produced later is intended to carry out in the resultant moulding and can be adjusted correspondingly.

The three-dimensional pattern formed by bumps and/or pits on the outside surface of the preform can be obtained in various ways. If the preform is a polymeric preform made of plastic, the preform can, for example, be produced in an injection-moulding process at the same time as the three-dimensional pattern on its outside surface or the three-dimensional pattern on the surface of a prefabricated polymeric preform can be obtained by laser engraving, to mention just a few examples.

If the preform consists of a material other than plastic, for example of metal, the three-dimensional pattern on its surface can be produced, for example, by casting or die casting at the same time as the production of the preform, but also by stamping or other material-removing cutting processes on the surface of the metal preform.

For the process according to the invention, the way in which the preform including the three-dimensional pattern located on its outside surface is produced is unimportant. In accordance with the present invention, however, the three-dimensional pattern should be a pattern of bumps and/or pits, preferably haptically perceptible, on the surface of the preform which do not determine the outer shape of the preform and are unambiguously recognisable as texture on its outside surface.

If only a part-area of the outside surface of the preform is arranged facing the cavity of the injection mould, it goes without saying in accordance with the present invention that the three-dimensional pattern of bumps and/or pits is located on precisely this part-area of the outside surface of the preform.

The plastic materials employed in the thermoplastic film and in the preform are preferably identical, partly identical or at least similar in their melting points and their melting behaviour in order to ease complete material bonding of these polymeric constituents of the moulding during the injection-moulding process and to facilitate an unbreakable, strong and positive bond. The starting materials for the thermoplastic film and also the starting materials for the components which are capable of polymerisation with one another can be selected in accordance with this prerequisite.

If desired, an adhesion-promoting layer applied to the surface of the thermoplastic film projecting into the cavity of the injection mould may also be helpful in the thermal bonding of the film and the transparent plastic formed by polymerisation of the reactive components. This also applies to a thermal non-compatibility of the binder systems of a pigmented print layer or coating on the thermoplastic film, since the print layer or coating, if present, are preferably located on the surface of the thermoplastic film projecting into the cavity of the injection mould. The adhesion-promoting layer ensures an unbreakable bond of film and transparent plastic formed in situ and can be selected by the person skilled in the art on the basis of his expert knowledge.

In a similar way, an adhesion-promoting layer may also be provided between the thermoplastic film pigmented with effect pigments and the preform.

Suitable polymeric plastic materials for the thermoplastic film are the conventional thermoplastic materials, such as, for example, polystyrene (PS), polypropylene (PP), polyamide (PA) polycarbonate (PC), polymethyl methacrylate (PMMA), styrene-acrylonitrile (SAN), acrylatestyrene-acrylonitrile (ASA), various thermoplastic elastomers (TPEs or TPOs), acrylonitrile-butadiene-styrene (ABS) or ABS/PC blends, to mention just a few. It is also possible to employ further copolymers which are different from the copolymers mentioned above and which contain the above-mentioned polymers.

The films shaped from the thermoplastic materials are in accordance with the invention pigmented with flake-form effect pigments. The flake-form effect pigments here can be introduced into or applied to the thermoplastic film in various ways. Thus, the flake-form effect pigments can be applied to the entire surface or part of a surface of the thermoplastic film as constituent of a printing ink or coating composition, but they can also be applied, in the case of metal-effect pigments, to the surface of the film with the aid of a vapour deposition process. In each case, coating is preferably carried out over the entire area. The process steps and materials required for the various coating methods are familiar to the person skilled in the art and do not have to be described in greater detail here.

However, the pigmentation of the thermoplastic film is very particularly preferably carried out via mass colouring of the film. This means that flake-form effect pigments in suitable shape and amount are added to the polymeric plastics as early as during production of the film and are converted into films together with the plastics, which is generally carried out by extrusion. This can be carried out by direct addition of flake-form effect pigments to plastic granules or also by the preparation of compounds comprising effect pigments or through masterbatches with subsequent common granulation.

Combined pigmentation of the film with the aid of mass colouring and an additional printing or coating process is also possible.

The pigmented thermoplastic film employed in accordance with the invention comprises the flake-form effect pigments in an amount of 0.1 to 20% by weight, based on the total weight of the pigmented film. Proportions of 0.5 to 5% by weight are particularly preferred here. All pigment proportions here are based on the pigmented film, i.e. on the coated, printed or mass-coloured film. In addition to the flake-form effect pigments, the pigmented thermoplastic film may also comprise further inorganic or organic coloured pigments, dyes and/or fillers. The conventional colorants and fillers generally employed for the colouring of plastic films or printing inks or coating compositions are suitable here so long as they do not permanently hinder the optical effects achieved by the flake-form effect pigments. For certain polymers, for example PET, preference is given to organic dyes, which are soluble in the polymeric plastic material and uniformly colour the resultant films without having an interfering particulate character.

Other polymer films or binders may also be provided with organic or inorganic coloured pigments or fillers in particle form.

The flake-form effect pigments employed in the process in accordance with the present invention can be all known flake-form effect pigments so long as they are visible in or on the thermoplastic film. Flake-form effect pigments of this type are advantageously selected from the group pearlescent pigments, interference pigments, metal-effect pigments, flake-form functional pigments, flake-form structured pigments, or a mixture thereof. These effect pigments are built up from one or more layers of different materials and are in flake form.

These pigments preferably have a flake-form substrate on which one or more layers are located, where at least the substrate and the layer located directly on the substrate and/or at least two layers of the coating which are in each case adjacent differ from one another in their refractive indices n at least by the value Δn=0.1. The layers located on the substrate here are preferably metals, metal oxides, metal oxide hydrates or mixtures thereof, metal mixed oxides, suboxides, oxynitrides, metal fluorides or polymer materials.

Pearlescent pigments consist of transparent flakes of high refractive index and exhibit a characteristic pearlescence due to multiple reflection in the case of parallel orientation. Pearlescent pigments of this type which additionally also exhibit interference colours are known as interference pigments.

Although classical pearlescent pigments, such as TiO₂ flakes, basic lead carbonate, BiOCl pigments or nacreous pigments, are naturally also suitable in principle, the effect pigments employed for the purposes of the invention are preferably flake-form interference pigments or metal-effect pigments, which have at least one coating of a metal, metal oxide, metal oxide hydrate or mixtures thereof, a metal mixed oxide, metal suboxide, metal oxynitride, metal fluoride or a polymer on a flake-form substrate.

The metal-effect pigments preferably have at least one metal substrate or a metal coating.

The flake-form substrate preferably consists of natural or synthetic mica, kaolin or another phyllosilicate, glass, calcium aluminium borosilicate, SiO₂, TiO₂, Al₂O₃, Fe₂O₃, polymer flakes, graphite flakes or metal flakes, such as, for example, of aluminium, titanium, bronze, silver, copper, gold, steel or diverse metal alloys.

Particular preference is given to flake-form substrates comprising mica, glass, calcium aluminium borosilicate, graphite, SiO₂, Al₂O₃ or aluminium.

The size of the flake-form substrates is not crucial per se, but the flake-form effect pigments must be visible in or on the thermoplastic film and be capable of being oriented with or in the film. The substrates generally have a thickness of between 0.01 and 5 μm, in particular between 0.05 and 4.5 μm and particularly preferably from 0.1 to 1 μm. The length or width dimension is usually from 5 to 250 μm, preferably from 5 to 100 μm and in particular from 5 to 125 μm. They generally have an aspect ratio (ratio of mean diameter to mean particle thickness) of at least 2:1, preferably of from 3:1 to 500:1 and in particular from 6:1 to 250:1.

The said dimensions for the flake-form substrates also apply in principle to the coated effect pigments used in accordance with the invention, since the additional coatings are generally in the region of only a few hundred nanometres and thus do not significantly influence the thickness or length or width (particle size) or thickness of the pigments.

A coating applied to the support preferably consists of metals, metal oxides, metal mixed oxides, metal suboxides or metal fluorides and in particular of a colourless or coloured metal oxide selected from TiO₂, titanium suboxides, titanium oxynitrides, Fe₂O₃, Fe₃O₄, SnO₂, Sb₂O₃, SiO₂, Al₂O₃, ZrO₂, B₂O₃, Cr₂O₃, ZnO, CuO, NiO or mixtures thereof.

Coatings of metals are preferably of aluminium, titanium, chromium, nickel, silver, zinc, molybdenum, tantalum, tungsten, palladium, copper, gold, platinum or alloys comprising these.

The metal fluoride employed is preferably MgF₂.

Particular preference is given to effect pigments which have a flake-form substrate comprising mica, glass, calcium aluminium borosilicate, graphite, SiO₂, Al₂O₃ or aluminium and at least one layer on the substrate, selected from TiO₂, titanium suboxides, titanium oxynitrides, Fe₂O₃, Fe₃O₄, SnO₂, Sb₂O₃, SiO₂, Al₂O₃, MgF₂, ZrO₂, B₂O₃, Cr₂O₃, ZnO, CuO, NiO or mixtures thereof.

The effect pigments can have a multilayered structure in which a plurality of layers, which preferably consist of the above-mentioned materials and have different refractive indices in such a way that in each case at least two layers of different refractive index are located alternately on the support, where the refractive indices in the individual layers differ by at least 0.1 and preferably by at least 0.3 from one another, are located one above the other on a metallic or non-metallic support. The layers located on the support here may be either colourless or coloured, predominantly transparent, semi-transparent or even opaque.

Depending on the substrate material used and the type of layers applied, the effect pigments obtained are thus also colourless or have a mass tone, or are predominantly transparent, semi-transparent or opaque. Due to the single- or multilayered system on the substrate, however, they are additionally capable of producing more or less intense and glossy interference colours.

Preference is given to the use of the flake-form effect pigments which consist of predominantly transparent materials and have interference effects or also metal pigments, in particular aluminium pigments, which have been coated with interference layers.

However, the flake-form effect pigments employed can also be polymer flakes referred to as holographic pigments or pure metal flakes. In addition, it is also possible to employ flake-form effect pigments whose choice of material in substrate or coating additionally results in magnetic, electrically conductive, fluorescent or other functional properties of the corresponding effect pigments.

The effect pigments described above may be present individually or as a mixture of two or more in the pigmented thermoplastic film employed in accordance with the invention.

Effect pigments which can be employed are, for example, the commercially available functional pigments, interference pigments or pearlescent pigments offered by Merck KGaA under the names Iriodin®, Colorstream®, Xirallic®, Miraval®, Ronastar®, Biflair®, Minatec®, Lustrepak®, Colorcrypt®, Colorcode® and Securalic®, Mearlin® from Mearl, metal-effect pigments from Eckart and optically variable effect pigments, such as, for example, Variochrom® from BASF, Chromafflair® from Flex Products Inc., Helicone® from Wacker, holographic pigments from Spectratec and other commercially available effect pigments.

The geometrical thickness of the pigmented thermoplastic film employed in accordance with the invention can vary in a broad range and is preferably in the range from 20 to 2000 μm, in particular from 50 to 1000 μm. These figures relate both to printed/coated films and also to mass-coloured films.

Suitable materials for the mixture of at least two flowable components which are capable of polymerisation with one another are all substance mixtures which can be processed in the known RIM moulds and give transparent plastics in situ by polymerisation of the at least two components with another.

Known suitable mixtures are two-component mixtures that give polyurethane or polyurea plastics by polymerisation. Mixtures of this type generally comprise a liquid binder component and a liquid hardener or crosslinker component. The known systems often comprise, as liquid binder component, an isocyanate-reactive component, such as polyamines or polyols, while the liquid crosslinking component comprises an isocyanate. The two components react by polyaddition on mixing to give crosslinked polyurea or polyurethane plastics. The crosslinking reaction here proceeds even under moderate temperature and pressure conditions.

The liquid reactive mixtures which can be employed in the process according to the invention therefore preferably comprise at least one isocyanate component and at least one isocyanate-reactive component, for example a polyol or a polyamine.

In addition, catalysts, assistants and additives, particulate fillers, parting agents or also polymerisation retardants can additionally be added if necessary.

Isocyanate-reactive polyols which have proven particularly suitable for the polyurethane preparation are, inter alia, polymeric or oligomeric polyols, such as, for example, polyether-polyols, polyester-polyols and/or polycarbonate-polyols.

Isocyanate-reactive polyamines preferably employed are polymeric or oligomeric polyamines, such as, for example, polyether-polyamines and/or polyester polyamines.

Suitable isocyanate compounds are, in particular, aromatic, araliphatic, aliphatic or cycloaliphatic di- and/or polyisocyanates or mixtures thereof. In certain embodiments, the isocyanate component comprises a diisocyanate of the formula R(NCO)₂, where R represents an aliphatic hydrocarbon radical having 4 to 12 carbon atoms, a cycloaliphatic hydrocarbon radical having 6 to 15 carbon atoms, an aromatic hydrocarbon radical having 6 to 15 carbon atoms or an araliphatic hydrocarbon radical having 7 to 15 carbon atoms. Specific examples of suitable isocyanate compounds are xylylene diisocyanate, tetramethylene diisocyanate, 1,4-diisocyanatobutane, 1,12-diisocyanatododecane, hexamethylene diisocyanate, 2,3,3-trimethylhexamethylene diisocyanate, 1,4 cyclohexylene diisocyanate, 4,4′-dicyclohexylmethane diisocyanate, 4,4′-dicyclohexyl diisocyanate, 1,4-phenylene diisocyanate, 2,6-toluylene diisocyanate, 2,4-toluylene diisocyanate, 1,5-naphthylene diisocyanate, 2,4′- or 4,4′-diphenylmethane diisocyanate, 4,4′-diphenldimethylmethane diisocyanate, a,a,a′,a′-tetramethyl-m-xylylene diisocyanate, a,a,a′,a′-tetramethyl-p-xylylene diisocyanate, triphenylmethane 4,4′,4″-triisocyanate or mixtures thereof. Also suitable are monomeric triisocyanates or polyisocyanate adducts which contain isocyanurate, iminooxadiazindione, urethane, biuret, allophenate, uretdione, and/or carbodiimide groups. The isocyanates can contain 3 or more isocyanate functionalities and can be prepared, for example, by trimerisation or oligomerisation of diisocyanates or by reaction of diisocyanates with polyfunctional compounds containing hydroxyl or amine groups.

In addition, the coating compositions may additionally comprise silicone compounds.

Other thermocuring resins can also be prepared in this process step if their preparation in the injection mould does not lead to undesired byproducts. For example, anionic polymerisation of ε-caprolactam to PA6 by means of suitable catalysts is just as possible as the preparation of thermocuring polydicyclopentadiene resins or thermocuring polyester resins. However, preference is given to the use of reactive components which lead to polyurethanes or polyureas as surface coating on the thermoplastic film.

The liquid, reactive starting materials for the in situ preparation of the transparent plastic can be employed in colourless or coloured form and give transparent plastic layers after solidification.

The outer layer of transparent plastic which forms the outside surface of the resultant moulding additionally enhances the virtual three-dimensional pattern of flake-form effect pigments obtained in the interior of the moulding through an additional optical depth effect.

The present invention also relates to a moulding which consists at least of a preform, an interlayer, located on the preform, of a thermoplastic which has been pigmented with flake-form effect pigments, and an outer surface layer comprising a transparent plastic, where the outer surface layer exhibits on at least one part-area thereof a visually perceptible, virtual three-dimensional pattern which is formed in the interior of the moulding by the flake-form effect pigments, and where the outer surface layer of the moulding itself does not have a corresponding spatial three-dimensional pattern. Such mouldings are produced by the above-described injection-moulding process according to the invention.

The moulding in accordance with the present invention is a polymeric moulding or a composite moulding.

Whereas in the case of a polymeric moulding the preform likewise consists substantially of a polymeric material, i.e. of a plastic, in the case of a composite moulding the preform is composed predominantly of a material other than plastic and preferably consists of a metal.

The thermoplastic film pigmented with flake-form effect pigments that is used in the production of the moulding according to the invention forms, in the resultant moulding, the above-mentioned interlayer of a thermoplastic which has been pigmented with flake-form effect pigments. On solidification (crosslinking), the outer surface layer of the moulding according to the invention comprising transparent plastic is formed from the mixture of at least two flowable components which react with one another with polymerisation.

The material compositions of preform, thermoplastic film, flake-form effect pigments and transparent plastic have already been described in detail above. Reference is expressly made here to this description with respect to the moulding according to the invention.

The moulding according to the invention optionally advantageously has an adhesion-promoting layer between the pigmented thermoplastic film and the cured transparent plastic produced in situ. This layer consists of one or more polymeric plastics and forms an unbreakable, strongly adherent bond between the thermoplastic film and the transparent plastic. The choice of suitable material can be made by the person skilled in the art on the basis of his expert knowledge in accordance with the respective requirement.

If necessary for the above-mentioned reasons, an adhesion-promoting layer may also be provided between the film pigmented with the flake-form effect pigments and the preform. This may play a role, in particular, on use of metallic preforms.

The virtual three-dimensional pattern visible on the outside surface (visible side) of the moulding according to the invention is the positive copy of the bumps and/or pits which are located on the surface of the preform. However, this copy is produced principally by the different orientation of flake-form effect pigments in or on the thermoplastic interlayer located in the interior of the moulding according to the invention, whereas the three-dimensional pattern actually located on the surface of the preform in the resultant moulding is only weakly visible or is invisible.

As already described above, the size of the vertical and horizontal extent of the visible three-dimensional pattern on the outside surface of the moulding according to the invention can vary in broad ranges, which is selected depending on the size of the preform and the thickness of the thermoplastic film and the intended purpose of the three-dimensional pattern on the moulding (example: code versus decorative effect). The thickness of the thermoplastic film generally represents the upper limit for the height or depth of the bumps and/or pits on the surface of the preform, but in individual cases these may also exceed the thickness of the thermoplastic film.

The three-dimensional pattern on the outside surface of the preform has bumps and/or pits from a height/depth of about 2 μm to a few centimetres and line widths of 100 μm to 2000 μm. The area of the three-dimensional pattern can range from a few square millimetres to a several hundred square centimetres and is, like the height/depth and width of the pits or bumps, adjusted in accordance with the above-mentioned criteria.

The surface of the preform that contains the three-dimensional pattern is located here in the interior of the moulding and cannot be separated therefrom.

Flake-form effect pigments are likewise arranged in the interior of the moulding in a thermoplastic interlayer between the preform and the outside surface of the moulding. This interlayer also cannot be separated from the other constituents of the moulding.

The flake-form effect pigments arranged in the interlayer in each case have a longitudinal axis which corresponds to the longest dimension of the pigments and have different orientations of these longitudinal axes in the interlayer, relative to a base area of the interlayer, as has already been described above. This different orientation of the flake-form effect pigments leads to different light reflection of the effect pigments in the case of incident light and leads to a virtual, glossy pattern with a three-dimensional appearance in the interior of the moulding according to the invention which is visible on its outside surface, but is not haptically perceptible.

Instead, the outer surface layer of the moulding consists of a transparent plastic and preferably has, apart from the outer shape, no additional surface structure. In individual cases, however, such an additional texture/structure of the outside surface may be appropriate or sensible. The thickness of the outer surface layer comprising a transparent plastic prepared in situ can, in accordance with the invention, be matched variably to the respective requirements for use of the final moulding. It can be in the range from 0.1 to 30 mm, preferably in the range from 0.1 to 20 mm and particularly preferably in the range from 0.1 to 5 mm.

In contrast to the outer surface layer of the moulding, the preform can be transparent, translucent or opaque. It is particularly advantageous if the preform is colourless or coloured, but opaque, in particular if it is coloured grey or black and is preferably additionally opaque. This enables an increase in the contrast and visibility of the virtual, three-dimensional pattern formed in the interior of the moulding by the flake-form effect pigments.

The virtual three-dimensional pattern visible on the outside surface of the moulding is as such not haptically perceptible on this surface and is therefore protected against mechanical influences. At the same time, it is readily perceptible and optically attractive due to the different light reflection of the flake-form effect pigments. The transparent plastic layer forming the surface of the moulding increases the impression of depth and thus the optically perceptible three-dimensionality of the pattern. In addition, the surface of the moulding has, due to the materials used, high impact strength and scratch resistance and can be provided in its feel and optics from hard and high-gloss to matt and with a soft-touch feel. Variable textures on the outside surface, which can advantageously supplement the three-dimensional virtual pattern formed by the effect pigments, are likewise possible.

The present invention also relates to the use of the moulding described above as decorative and/or labelling element or part of durable consumer goods.

Durable consumer goods here are essentially and preferably packaging, products in the electrical and electronics industry, domestic appliances, furniture, clothing, bags, shoes, sports articles or in particular vehicles and vehicle parts. In principle, however, the mouldings according to the invention can be employed in all areas in which it is advantageous to employ mouldings that can be produced in an RIM injection-moulding process and have a readily visible, attractive three-dimensional pattern which at the same time cannot be felt on the surface. In articles of this type, the virtual three-dimensional pattern can be employed for purely creative, decorative reasons, but also for the purpose of product labelling with batch numbers, manufacturer's data and the like.

The present invention provides a simple and variable injection-moulding process with the aid of which it is possible to produce mouldings which exhibit on at least one of their surfaces a glossy, optically attractive, virtual three-dimensional pattern which exhibits an appearance which can be varied in colour, gloss and functionality and may contain fine lines with high precision. These can be polymeric mouldings which are substantially composed of plastics, but also composite mouldings which have a core of a material other than plastics. For many areas of application of injection mouldings which require special materials, a process is thus created for improving their optical appearance which was hitherto not available. Furthermore, the process according to the invention has the advantage that, even in the case of polymeric mouldings, achievement of impressive three-dimensional patterns which are based on the spatial alignment of flake-form effect pigments does not require pigmentation of the entire polymeric moulding with these flake-form effect pigments, but instead only part of the moulding, which, as required, may also be relatively small (example only 10% by weight), based on the total weight of the polymeric moulding. The process according to the invention can be carried out using conventional RIM injection-moulding equipment and is therefore comparatively inexpensive and can be adapted in line with needs. With the aid of the process according to the invention, complex mouldings having a mechanically stable surface which are free from flow lines and are coloured and patterned impressively with effect pigments can be produced in a simple, variable manner. The resultant mouldings according to the invention are durable and generally have an unembossed surface of high visual and mechanical attractiveness and a virtually indestructible three-dimensional virtual pattern having high line sharpness. They have a uniform colour and if desired, high gloss and can be employed in a variable manner in many industrial and decorative areas of application.

The invention will be explained in greater detail below with reference to examples, but is not intended to be restricted thereto.

### EXAMPLE 1

A preform made from PC/ABS (Xantar® C CM 406, product from Mitsubishi Engineering Plastics, Co.) having a carbon black content of 1% by weight, based on the weight of the plastic, a size of 100×150 mm and a thickness of 4 mm is injection-moulded in an upstream process step. One of the principal surfaces of the preform is provided with a logo. The logo has various pits of 100-600 μm each.

A film produced by means of an injection-moulding process (PC/ABS, Xantar® C CM 406, product from Mitsubishi Engineering Plastics, Co.) having a content of 1.5% by weight of Colorstream® T10-09 Pacific Twinkle (flake-form effect pigment based on SiO₂ substrates, particle size 20-200 μm, product from Merck KGaA) and 0.2% by weight of PV Fast Blue B2G01 (product from Clariant International Ltd.) having a thickness of about 800 μm is produced in a size of 100×150 mm.

The preform produced in advance is applied to an inside surface of the injection mould part in a suitable RIM injection mould in such a way that the logo faces the interior cavity of the injection mould. The pigmented, mass-coloured film is then placed in the remainder of the cavity, and the mould is closed. A reactive mixture (2-component PUR system) is introduced into the cavity still remaining between the pigmented film and the free inside surface of the injection mould and allowed to cure.

After the cooling operation and opening of the mould, a plastic plate is obtained whose first outside surface exhibits an area with uniformly strong blue gloss which changes colour between blue and green and gives the impression of lying behind glass, with a glossy, finely structured virtual three-dimensional pattern located therein in the form of a logo which is formed by the flake-form effect pigments in the film and which corresponds to the motif of the logo on the surface of the prefabricated plastic plate containing carbon black. The other principal surface of the plastic plate obtained is flat, opaque and has a black colour.

The reactive mixture used as a mixture of 49% by weight of component 1, consisting of Desmophen® XP2488 (24.15% by weight), Desmophen® C1100 (24.15% by weight), Dabco® T-12 (0.5% by weight) and FC 983 (0.2% by weight), and 51% by weight of component 2, consisting of Desmodur® N-3600, all products from Bayer MaterialScience.

### COMPARATIVE EXAMPLE 1

A preform made from PC/ABS (Xantar® C CM 406, product from Mitsubishi Engineering Plastics, Co.) having a content of 1.5% by weight of Colorstream® T10-09 Pacific Twinkle and 0.2% by weight of PV Fast Blue B2G01, based on the weight of the plastic, a size of 100×150 mm and a thickness of 4 mm is injection-moulded in an upstream process step. One of the principal surfaces of the preform is provided with a logo. The logo has various pits of about 100-600 μm each.

The preform produced in advance is applied to an inside surface of the injection mould part in a suitable RIM injection mould in such a way that the logo faces the interior cavity of the injection mould. The mould is subsequently closed. A reactive mixture (2-component PUR system) is introduced into the cavity between the preform and the free inside surface of the injection mould and allowed to cure.

After the cooling operation and opening of the mould, a plastic plate is obtained whose first outside surface exhibits an area with blue gloss which changes colour between pale blue and green and gives the impression of lying behind glass, with a glossy, virtual three-dimensional pattern located therein in the form of a logo which corresponds to the motif of the logo on the surface of the preform. The other principal surface of the plastic plate obtained is flat, semitransparent and likewise changes colour between pale blue and green. Compared with Example 1, the visible three-dimensional pattern has lower edge sharpness and less optical depth.

The reactive mixture used is a mixture of 49% by weight of component 1, consisting of Desmophen® XP2488 (24.15% by weight), Desmophen® C1100 (24.15% by weight), Dabco® T-12 (0.5% by weight) and FC 983 (0.2% by weight), and 51% by weight of component 2, consisting of Desmodur® N-3600, as in Example 1.

### COMPARATIVE EXAMPLE 2

A preform made from PC/ABS (Xantar® C CM 406, product from Mitsubishi Engineering Plastics, Co.) having a size of 100×150 mm and a thickness of 4 mm is injection-moulded in an upstream process step. One of the principal surfaces of the preform is provided with a logo. The logo has various pits of about 100-600 μm each.

A commercially available lacquer which comprises a mixture of 5% by weight of Colorstream® T10-09 Pacific Twinkle and 0.2% by weight of PV Fast Blue B2G01, based on the weight of the lacquer, is applied to the surface of the preform that is provided with the logo and dried.

The preform produced in advance is applied to an inside surface of the injection mould part in a suitable RIM injection mould in such a way that the logo faces the interior cavity of the injection mould. The mould is subsequently closed. A reactive mixture (2-component PUR system) is introduced into the cavity between the preform and the free inside surface of the injection mould and allowed to cure.

After the cooling operation and opening of the mould, a plastic plate is obtained whose first outside surface exhibits an area with blue gloss which changes colour between pale blue and green and gives the impression of lying behind glass, with a glossy, virtual three-dimensional pattern located therein in the form of a logo which corresponds to the motif of the logo on the surface of the preform. The other principal surface of the plastic plate obtained is flat, transparent and virtually colourless. The three-dimensional pattern on the visible surface has weak contours and colour flaking in the background at the motif edges.

The reactive mixture used is a mixture of 49% by weight of component 1, consisting of Desmophen® XP2488 (24.15% by weight), Desmophen® C1100 (24.15% by weight), Dabco® T-12 (0.5% by weight) and FC 983 (0.2% by weight), and 51% by weight of component 2, consisting of Desmodur® N-3600, as in Example 1.

1. Reactive injection-moulding process for the generation of virtual three-dimensional patterns in mouldings, where
an injection mould is provided which has injection mould parts A and B which can be separated from one another and which in each case have an inside surface A′ and B′ and together form an interior cavity, and where, with the injection mould opened,
a preform which has a two- or three-dimensional shape and an outside surface is fixed to the inside surface A′ of injection mould part A in such a way that the outside surface of the preform faces the cavity, where this outside surface has, at least on a part-area thereof, bumps and/or pits which together form a three-dimensional pattern,
a thermoplastic film which has been pigmented with flake-form effect pigments is introduced into the interior cavity,
the injection mould is closed,
a mixture of at least two flowable components which react with one another with polymerisation is introduced into the interior cavity between the thermoplastic film and the surface B′ of injection mould part B, so that the thermoplastic film is at least partly covered, where the flowable components solidify with one another by polymerisation to give a transparent plastic and the thermoplastic film forms a strongly adherent and positive bond to at least that part of the outside surface of the preform that contains the three-dimensional pattern and at the same time to the transparent plastic formed during the polymerisation, and
where the flake-form effect pigments replicate and optically enhance the three-dimensional pattern located on the outside surface of the preform on or in the thermoplastic film,
the injection mould is heated or cooled and subsequently
the resultant moulding, which has an outside surface comprising a transparent plastic and exhibits on at least part of this outside surface a virtual three-dimensional pattern formed by the flake-form effect pigments, is demoulded or removed.

2. Process according to claim 1, characterised in that the thermoplastic film has been mass-coloured with flake-form effect pigments.

3. Process according to claim 1, characterised in that the three-dimensional pattern is a macroscopic pattern in the form of a pictorial object, an alphanumeric motif, a line and/or dot pattern, a logo, a code or a an abstract pattern.

4. Process according to claim 1, characterised in that the flake-form effect pigments are selected from the group pearlescent pigments, interference pigments, metal-effect pigments, flake-form functional pigments, flake-form structured pigments, or a mixture thereof.

5. Process according to claim 1, characterised in that the flake-form effect pigments have a particle size in the range from 5 to 250 μm and an aspect ratio of at least 2.

6. Process according to claim 1, characterised in that the flake-form effect pigments consist of a flake-form substrate and one or more layers on the substrate, where the substrate and the layer located directly on the substrate and/or at least two layers which are in each case adjacent differ from one another in their refractive indices n at least by Δn=0.1.

7. Process according to claim 1, characterised in that the flake-form effect pigments are present in the pigmented thermoplastic film in an amount of 0.1 to 20% by weight, based on the total weight of the pigmented film.

8. Process according to claim 1, characterised in that the pigmented thermoplastic film, in addition to the flake-form effect pigments, also comprises further organic or inorganic coloured pigments, dyes and/or fillers.

9. Moulding which consists at least of a preform, an interlayer, located on the preform, of a thermoplastic which has been pigmented with flake-form effect pigments, and an outer surface layer comprising a transparent plastic, where the outer surface layer exhibits on at least one part-area thereof a visually perceptible, virtual three-dimensional pattern which is formed in the interior of the moulding by the flake-form effect pigments, and where the outer surface layer of the moulding does not itself have a corresponding spatial three-dimensional pattern, obtained according to claim 1.

10. Moulding according to claim 9, characterised in that it is a polymeric moulding or a composite moulding.

11. Moulding according to claim 9, characterised in that the flake-form effect pigments in each case have a longitudinal axis and these longitudinal axes are in different orientations in the interlayer, relative to a base area of the interlayer.

12. Moulding according to 9, characterised in that the preform is transparent, translucent or opaque.

13. A decorative and/or labelling element or durable consumer goods containing therein a moulding according to claim 9.

14. Durable consumer goods according to claim 13 that are packaging, products in the electrical and electronics industry, domestic appliances, furniture, clothing, leather goods, shoes, sports articles or vehicles.
